(19) United States
(12) Patent Application Publication
(10) Pub. No.: US 2021/0142365 A1
(43) Pub. Date: May 13, 2021

(54) METHOD AND SYSTEM FOR REAL TIME ADVERTISEMENT AUCTION ON TELECOMMUNICATION NOTIFICATION CHANNELS

(71) Applicant: Terragon Holdings Mauritius, Ebene (MU)

(72) Inventors: Elochukwu UMEH, Lagos (NG); Ayodeji Balogun, Lagos (NG); Amit Khemchandani, Bengaluru (IN); Mohit Rawat, Bengaluru (IN)

(73) Assignee: Terragon Holdings Mauritius, Ebene (MU)

(21) Appl. No.: 16/680,400

(22) Filed: Nov. 11, 2019

(51) Int. Cl. G06Q 30/02

(52) U.S. Cl. CPC G06Q 30/0269; G06Q 30/0275; G06Q 30/0201; G06Q 30/0255; G06Q 30/0277; G06Q 30/0261; G06Q 30/0205

(57) ABSTRACT

The present disclosure provides a computer-implemented method and system for real time advertisement auction on telecommunication notification channels. The computer-implemented method and system corresponds to an advertisement serving system. The advertisement serving system integrates a plurality of advertisers and one or more telecommunication notification channels. In addition, the advertisement serving system receives a subscriber data, a subscriber interaction data associated with a plurality of subscribers. Further, the advertisement serving system receives an advertiser data associated with the plurality of advertisers. Furthermore, the advertisement serving system analyzes the subscriber data, the subscriber interaction data and the advertiser data. Moreover, the advertisement serving system determines a subscriber context data. Also, the advertisement serving system generates a plurality of categories. Also, the advertisement serving system sends request to the plurality of advertisers for bidding. In addition, the advertisement serving system determines the highest bid and serves one or more advertisements.

### TECHNICAL FIELD

The present invention relates to the field of marketing and, in particular, relates to real time advertisement auction on telecommunication notification channels.

### BACKGROUND

Over the past few years, Internet and non-internet marketing is the fastest growing advertising medium in the last few years. Due to the advent telecommunication service providers, a vast number of subscribers are engaged on the telecommunication notification channels through their communication devices. Telecommunication service providers have access to huge amount of information about the subscribers who are regularly using telecommunication services. Advertisers and telecommunication service providers have made use of this information of the subscribers for generating and sharing revenue between each other. In addition, the telecommunication service providers utilize this information for offering opportunities for advertising and marketing to advertisers through their telecommunication notification channels. Moreover, this information is accessed using the technologies available today which provide telecommunication services providers with valuable data for advertising purposes. However, the present systems and methods for accessing the information of the subscribers for the advertisements are inefficient. In addition, at present, the telecommunication notification channels inventory is sold at the same flat pricing regardless of the subscriber context.

In the light of the above stated discussion, there is a need for system that overcomes the above stated disadvantages.

### SUMMARY

In a first example, a computer-implemented method is provided. The computer-implemented method performs real time advertisement auction on telecommunication notification channels. The computer implemented method corresponds to an advertisement serving system with a processor. The computer-implemented method includes a first step to integrate a plurality of advertisers and one or more telecommunication notification channels with the advertisement serving system. The plurality of advertisers is integrated through a plurality of advertising tech platforms. In addition, integration is done to serve one or more advertisements to a plurality of subscribers on the one or more telecommunication notification channels in real time. The plurality of subscribers is associated with one or more telecommunication service providers. In addition, the computer-implemented method includes a second step to receive a subscriber data associated with the plurality of subscribers. The subscriber data is received from the one or more telecommunication service providers. In addition, the subscriber data is received in real time. Further, the computer-implemented method includes a third step to obtain a subscriber interaction data associated with interaction of the plurality of subscribers on the one or more telecommunication notification channels. The subscriber interaction data is received from the one or more telecommunication service providers. In addition, the subscriber interaction data is received in real time. Furthermore, the computer-implemented method includes a fourth step to collect an advertiser data associated with the plurality of advertisers. The advertiser data is associated with the plurality of advertisers. In addition, the advertiser data is collected in real time. Moreover, the computer-implemented method includes a fifth step to analyze the subscriber data, the subscriber interaction data and the advertiser data. In addition, analysis is done using one or more machine learning algorithms in real time. Also, the computer-implemented method includes a sixth step to determine a subscriber context data. The subscriber context data is determined on the basis of analysis of the subscriber interaction data. In addition, the subscriber interaction data is associated with the plurality of subscriber. In addition, the computer-implemented method includes a seventh step to determine a plurality of categories. The plurality of categories is generated after analysis of the subscriber data, the subscriber interaction data and the advertiser data. In addition, the plurality of categories is based on one or more factors and the subscriber context data. Further, the one or more advertisements are provided to the plurality of subscribers based on the plurality of categories. Furthermore, the plurality of categories is generated in real time. Further, the computer-implemented method includes an eighth step to send request to the plurality of advertisers in real time. In addition, request is sent to notify the plurality of advertisers about space availability for advertisement on the one or more telecommunication notification channels. Furthermore, the computer-implemented method includes a ninth step to determine the highest bid from a plurality of bids received from the plurality of advertisers in real time. The plurality of bids is done by the plurality of advertisers to buy space for advertisement on the one or more telecommunication notification channels. In addition, the plurality of bidding is done in real time. Moreover, the computer-implemented method includes a tenth step to serve one or more advertisements on the one or more telecommunication notification channels through one or more communication devices. The one or more communication devices are associated with the plurality of subscribers. In addition, the one or more advertisements are served in real time.

In an embodiment of the present disclosure, the one or more telecommunication notification channels include web based communication, text messages, multimedia messages, flash messages, recharge notification and balance notification.

In an embodiment of the present disclosure, the plurality of advertising tech platforms includes demand side platforms, mobile advertising exchanges and data management platforms.

In an embodiment of the present disclosure, the subscriber data includes age, location, encrypted MSISDN, address, E-mail address and communication device details.

In an embodiment of the present disclosure, the subscriber interaction data includes calling behaviour, real time call status, balance enquiry request, balance status, call timings, call duration and location of calling.

In an embodiment of the present disclosure, the advertiser data includes name of advertiser, type of advertiser, space required for advertisement, type of advertisement, content of advertisement and duration of advertisement.

In an embodiment of the present disclosure, the subscriber context data includes type of text messages, type of calls, content of multimedia messages, subscriber choices, and subscriber behavior.

In an embodiment of the present disclosure, the one or more factors include location of subscriber, subscriber calling behaviour, type of advertisement, advertisement relevancy, and content of the advertisement.

In an embodiment of the present disclosure, the advertisement serving system sends request to the plurality of advertisers through real time bidding exchange. In addition, request is sent to the plurality of advertisers when the plurality of subscribers interacts with the one or more telecommunication notification channels.

In an embodiment of the present disclosure, the advertisement serving system receives the plurality of bids from real time bidding exchange, wherein the plurality of bids is done by the plurality of advertisers to buy space for advertisement on the one or more telecommunication notification channels.

In a second example, a computer system is provided. The computer system includes one or more processors, a signal generator circuitry embedded inside a computing device for generating a signal, and a memory. The memory is coupled to the one or more processors. The memory stores instructions. The instructions are executed by the one or more processors. The execution of the instructions causes the one or more processors to perform a method for real time advertisement auction on telecommunication notification channels. The method includes a first step to integrate a plurality of advertisers and one or more telecommunication notification channels with the advertisement serving system. The plurality of advertisers is integrated through a plurality of advertising tech platforms. In addition, integration is done to serve one or more advertisements to a plurality of subscribers on the one or more telecommunication notification channels in real time. The plurality of subscribers is associated with one or more telecommunication service providers. In addition, the method includes a second step to receive a subscriber data associated with the plurality of subscribers. The subscriber data is received from the one or more telecommunication service providers. In addition, the subscriber data is received in real time. Further, the method includes a third step to obtain a subscriber interaction data associated with interaction of the plurality of subscribers on the one or more telecommunication notification channels. The subscriber interaction data is received from the one or more telecommunication service providers. In addition, the subscriber interaction data is received in real time. Furthermore, the method includes a fourth step to collect an advertiser data associated with the plurality of advertisers. The advertiser data is associated with the plurality of advertisers. In addition, the advertiser data is collected in real time. Moreover, the method includes a fifth step to analyze the subscriber data, the subscriber interaction data and the advertiser data. In addition, analysis is done using one or more machine learning algorithms in real time. Also, the method includes a sixth step to determine a subscriber context data. The subscriber context data is determined on the basis of analysis of the subscriber interaction data. In addition, the subscriber interaction data is associated with the plurality of subscribers. In addition, the method includes a seventh step to determine a plurality of categories. The plurality of categories is generated after analysis of the subscriber data, the subscriber interaction data and the advertiser data. In addition, the plurality of categories is based on one or more factors and the subscriber context data. Further, the one or more advertisements are provided to the plurality of subscribers based on the plurality of categories. Furthermore, the plurality of categories is generated in real time. Further, the method includes an eighth step to send request to the plurality of advertisers in real time. In addition, request is sent to notify the plurality of advertisers about space availability for advertisement on the one or more telecommunication notification channels. Furthermore, the method includes a ninth step to determine the highest bid from a plurality of bids received from the plurality of advertisers in real time. The plurality of bids is done by the plurality of advertisers to buy space for advertisement on the one or more telecommunication notification channels. In addition, the plurality of bidding is done in real time. Moreover, the method includes a tenth step to serve one or more advertisements on the one or more telecommunication notification channels through the one or more communication devices. The one or more communication devices are associated with the plurality of subscribers. In addition, the one or more advertisements are served in real time.

In a third example, a non-transitory computer-readable storage medium is provided. The non-transitory computer-readable storage medium encodes computer executable instructions that, when executed by at least one processor, performs a method for real time advertisement auction on telecommunication notification channels. The method includes a first step to integrate a plurality of advertisers and one or more telecommunication channels with the advertisement serving system. The plurality of advertisers is integrated through a plurality of advertising tech platforms. In addition, integration is done to serve one or more advertisements to a plurality of subscribers on the one or more telecommunication notification channels in real time. The plurality of subscribers is associated with one or more telecommunication service providers. In addition, the method includes a second step to receive a subscriber data associated with the plurality of subscribers. The subscriber data is received from the one or more telecommunication service providers. In addition, the subscriber data is received in real time. Further, the method includes a third step to obtain a subscriber interaction data associated with interaction of the plurality of subscribers on one or more telecommunication notification channels. The subscriber interaction data is received from the one or more telecommunication service providers. In addition, the subscriber interaction data is received in real time. Furthermore, the method includes a fourth step to collect an advertiser data associated with the plurality of advertisers. The advertiser data is associated with the plurality of advertisers. In addition, the advertiser data is collected in real time. Moreover, the method includes a fifth step to analyze the subscriber data, the subscriber interaction data and the advertiser data. In addition, analysis is done using one or more machine learning algorithms in real time. Also, the method includes a sixth step to determine a subscriber context data. The subscriber context data is determined on the basis of analysis of the subscriber interaction data. In addition, the subscriber interaction data is associated with the plurality of subscribers. In addition, the method includes a seventh step to determine a plurality of categories. The plurality of categories is generated after analysis of the subscriber data, the subscriber interaction data and the advertiser data. In addition, the plurality of categories is based on one or more factors and the subscriber context data. Further, the one or more advertisements are provided to the plurality of subscribers based on the plurality of categories. Furthermore, the plurality of categories is generated in real time. Further, the method includes an eighth step to send request to the plurality of advertisers in real time. In addition, request is sent to notify the plurality of advertisers about space availability for advertisement on the one or more telecommunication notification channels. Furthermore, the method includes a ninth step to determine the highest bid from a plurality of bids received from the plurality of advertisers in real time. The plurality of bids is done by the plurality of advertisers to buy space for advertisement on the one or more telecommunication notification channels. In addition, the plurality of bidding is done in real time. Moreover, the method includes a tenth step to serve one or more advertisements on the one or more telecommunication notification channels through the one or more communication devices. The one or more communication devices are associated with the plurality of subscribers. In addition, the one or more advertisements are served in real time.

### BRIEF DESCRIPTION OF THE FIGURES

Having thus described the invention in general terms, reference will now be made to the accompanying drawings, which are not necessarily drawn to scale, and wherein:

FIG. 1 illustrates a block diagram of a system for real time advertisement auction on one or more telecommunication notification channels, in accordance with various embodiments of the present disclosure;

FIGS. 2A-2C illustrate a flowchart for real time advertisement auction on the one or more telecommunication notification channels, in accordance with various embodiments of the present disclosure; and

FIG. 3 illustrates a block diagram of a computing device, in accordance with various embodiments of the present disclosure.

It should be noted that the accompanying figures are intended to present illustrations of exemplary embodiments of the present disclosure. These figures are not intended to limit the scope of the present disclosure. It should also be noted that accompanying figures are not necessarily drawn to scale.

### DETAILED DESCRIPTION

In the following description, for purposes of explanation, numerous specific details are set forth in order to provide a thorough understanding of the present technology. It will be apparent, however, to one skilled in the art that the present technology can be practiced without these specific details. In other instances, structures and devices are shown in block diagram form only in order to avoid obscuring the present technology.

Reference in this specification to “one embodiment” or “an embodiment” means that a particular feature, structure, or characteristic described in connection with the embodiment is included in at least one embodiment of the present technology. The appearance of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but no other embodiments.

Moreover, although the following description contains many specifics for the purposes of illustration, anyone skilled in the art will appreciate that many variations and/or alterations to said details are within the scope of the present technology. Similarly, although many of the features of the present technology are described in terms of each other, or in conjunction with each other, one skilled in the art will appreciate that many of these features can be provided independently of other features. Accordingly, this description of the present technology is set forth without any loss of generality to, and without imposing limitations upon, the present technology.

FIG. 1 illustrates a block diagram of a system 100 for real time advertisement auction on one or more telecommunication notification channels, in accordance with various embodiments of the present disclosure. The system 100 includes a plurality of subscribers 102, one or more communication devices 104, a communication network 106, one or more telecommunication service providers 108, a server 114 and a database 116. In addition, the system 100 includes a plurality of advertisers 110 and an advertisement serving system 112. Further, the advertisement serving system 112 enables real time advertisement auction on the one or more telecommunication notification channels. In an embodiment of the present disclosure, real time advertisement auction on telecommunication notification channels is performed for serving one or more advertisements to the plurality of subscribers 102 in real-time.

The system 100 includes the plurality of subscribers 102. The subscriber may be any person or individual currently accessing one or more telecommunication notification channels through the one or more communication devices 104. The one or more telecommunication notification channels are associated with one or more telecommunication service providers 108. In an embodiment of the present disclosure, each of the one or more communication devices 104 is a portable communication device. The one or more communication devices 104 include but may not be limited to a smart phone, a desktop computer, a laptop, a tablet, a personal digital assistant, a wearable device and any other portable communication device known in the art. In addition, the one or more communication devices 104 are associated with a specific type of operating system. The specific type of operating system associated with the one or more communication devices 104 includes but may not be limited to an Android operating system, iOS, Mac operating system, Windows operating system, Bada operating system and Symbian operating system. In an embodiment of the present disclosure, the one or more telecommunication notification channels include but may not be limited to web based communication, text messages, multimedia messages, flash messages, recharge notification, balance notification.

Further, the one or more telecommunication service providers 108 are interlinked with the advertisement serving system 112 through the communication network 106. The one or more telecommunication service providers 108 transmit subscriber data and a subscriber interaction data to the advertisement serving system 112 through the communication network 106. The subscriber data and the subscriber interaction data are associated with the plurality of subscribers 102. In an embodiment of the present disclosure, the subscriber data includes but my not be limited to age, location, encrypted MSISDN, address, E-mail address and communication device details. In an embodiment of the present disclosure, the subscriber interaction data includes but may not be limited to calling behaviour, real time call status, balance enquiry request, balance status, call timings, call duration and location of calling. In addition, the one or more telecommunication service providers 108 send the subscriber data and the subscriber interaction data to the advertisement serving system 112 in real time.

In addition, the system 100 includes the plurality of advertisers 110. The plurality of advertisers 110 is those who want to advertise their products or service to the plurality of subscribers 102. The plurality of advertisers 110 interact with the one or more telecommunication service providers 108 and provide the one or more advertisements to be displayed for the plurality of subscribers 102 on the one or more telecommunication notification channels. The one or more advertisements are placed on the advertisement slots in the one or more telecommunication notification channels on the one or more communication devices 104 associated with the plurality of subscribers 102. The plurality of advertisers 110 purchase advertisement slots from the one or more telecommunication service providers 108. The one or more advertisements are served based on a real-time bidding technique or a direct contract between the plurality of advertisers 110 and the one or more telecommunication service providers 108.

Further, the plurality of advertisers 110 are interlinked with the advertisement serving system 112 through the communication network 106. The plurality of advertisers 110 transmits advertiser data to the advertisement serving system 112 through the communication network 106. In an embodiment of the present disclosure, the advertiser data includes name of advertiser, type of advertiser, space required for advertisement, type of advertisement, content of advertisement and duration of advertisement.

Furthermore, the system 100 includes the communication network 106 as shown in FIG. 1. In an embodiment of the present disclosure, the communication network 106 enables communication device to gain access to internet. In addition, internet connection is established based on a type of network. In an embodiment of the present disclosure, the type of network is a wireless mobile network. In another embodiment of the present disclosure, the type of network is a wired network with a finite bandwidth. In yet another embodiment of the present disclosure, the type of network is a combination of the wireless and the wired network for an optimum throughput of data transmission. Further, the communication network 106 includes set of channels. In addition, each channel of set of channels supports finite bandwidth. Further, finite bandwidth of each channel of the set of channels is based on capacity of network. The communication network 106 provides medium for sharing information among the communication devices 104, the one or more telecommunication service providers 108, the plurality of advertisers 110 and the advertisement serving system 112.

Moreover, the system 100 includes the advertisement serving system 112. The advertisement serving system 112 performs various operations for real time advertisement auction on the one or more telecommunication notification channels. The advertisement serving system 112 enables integration between the plurality of advertisers 110 and the one or more telecommunication notification channels. In addition, the plurality of advertisers 110 is integrated through a plurality of advertising tech platforms. In an embodiment of the present disclosure, the plurality of advertising tech platforms includes but may not be limited to demand side platforms, trading desks, mobile advertisement exchanges and data management platform. Further, the advertisement serving system 112 integrates the plurality of advertising tech platforms on one side and telecommunication service providers 108 on other side. Furthermore, the advertisement serving system 112 integrates a plurality of telecommunication nodes and the plurality of advertising tech platforms. In an embodiment of the present disclosure, the plurality of telecommunication nodes includes but may not be limited to short message service center, unstructured supplementary service data gateway, home location register, gateway GPRS support node, location based service and mobile web app.

Furthermore, the advertisement serving system 112 receives the subscriber data and the subscriber interaction data from the one or more telecommunication service providers 108 through the communication network 106. In addition, the advertisement serving system, 112 collects the advertiser data from the plurality of advertisers 110 through the communication network 106. In addition, the advertisement serving system 112 receives the subscriber data, the subscriber interaction data and the advertiser data in real time. In an embodiment of the present disclosure, the advertisement serving system 112 integrates the plurality of advertisers 110 and the one or more telecommunication notification channels. In addition, the integration is done to serve the one or more advertisements to the plurality of subscribers 102 on the one or more telecommunication notification channels in real time. The plurality of subscribers 102 is associated with one or more telecommunication service providers 108.

In addition, the advertisement serving system 112 analyses the subscriber data, the subscriber interaction data and the advertiser data in real time. In addition, the analysis of the subscriber data, the subscriber interaction data and the advertiser data is done using one or more machine learning algorithms. In an embodiment of the present disclosure, one or more machine learning algorithms include but may not be limited to linear regression, logistic regression, decision tree, sum of vector machine, naïve Bayes, k nearest neighbour, random forest, time series, k-means. In general, a machine learning algorithms are used to develop different models for datasets. In addition, datasets are divided into training dataset and test dataset. Further, training dataset is used to train the model that is developed using the machine learning algorithm. Furthermore, test dataset is used to test the efficiency and accuracy of the developed model.

Further, the advertisement serving system 112 determines a subscriber context data. The subscriber context data is determined based on analysis of the subscriber interaction data. In an embodiment of the present disclosure, the subscriber context data includes but may not limited to text messages, type of calls, content of multimedia messages, subscriber choices, and subscriber behavior. In addition, the subscriber context data is determined in real time.

Furthermore, the advertisement serving system 112 generates a plurality of categories. The plurality of categories is generated based on the subscriber context data and one or more factors. In an embodiment of the present disclosure, the one or more factors include but may not be limited location of subscriber, subscriber calling behaviour, type of advertisement, advertisement relevancy, and content of the advertisement. In addition, the one or more advertisements are provided to the plurality of subscribers 102 based on the plurality of categories. Further, the plurality of categories is generated in real time. In an embodiment of the present disclosure, the plurality of categories is based on location, calling behavior, subscriber behavior and the like.

In an example of the present disclosure, advertisement of international packs will be shown on telecommunication notification channel, if subscriber calls internationally. In another example of the present disclosure, if subscriber receives text message related to bank, advertisement related to banks will be shown on telecommunication notification channels. In yet another example of the present disclosure, advertisement relevant to location X will be shown on telecommunication notification channels, if subscriber is living in location X. In yet another example of the present disclosure, advertisement related to top up packs will be shown on telecommunication notification channels if subscriber has low balance.

Moreover, the advertisement serving system 112 sends request to the plurality of advertisers 110. The advertisement serving system 112 sends request to the plurality of advertisers 110 through real time bidding exchange. In addition, the request is sent to notify the plurality of advertisers 110 about space availability for advertisement on the one or more telecommunication notification channels. Further, the request is sent to the plurality of advertisers 110 when the plurality of subscribers 102 interacts with the one or more telecommunication notification channels. Furthermore, the request is sent to the plurality advertisers 110 in real time.

Also, the advertisement serving system 112 receives a plurality of bids from the real time bidding exchange. The bidding is done by the plurality of advertisers 110 to buy space for advertisement on the one or more telecommunication notification channels. In addition, the advertisement serving system 112 determines the highest bid from the plurality of bids received from real time bidding exchange.

In an embodiment of the present disclosure, the real time bidding exchange serves as market between the plurality of advertisers 110 and the one or more telecommunication service providers 108. In addition, the real time bidding exchange determines the one or more advertisements that match the available space for advertisements.

In addition, the advertisement serving system 112 serves the one or more advertisements on the one or more telecommunication notification channels through the one or more communication devices 104. In addition, the one or more communication devices are associated with the plurality of subscribers 102. Further, the one or more advertisements are served on the basis of the plurality of categories and the subscriber context data.

Also, the system 100 includes the database 116 as shown in FIG. 1. The database 116 is where all the information is stored for access at any point of time. The database 116 includes data which is pre-stored in the database 116 and data collected in real-time. The database 116 may be cloud database or any other database based on the requirement for real time advertisement auction on telecommunication notification channels. The data is stored in the database 116 in various tables. The tables are matrix that store different type of data in the form rows and columns. In an example, one table may store data related to the plurality of subscribers 102 and in other table the subscriber interaction data associated with the plurality of subscribers 102 is stored. The database 116 is included inside the server 114.

Further, the system includes the server 114. The server 114 is used to perform task of accepting request and respond to the request for other functions. The server 114 may be a cloud server which is used for cloud computing to enhance the real time processing of the system and using virtual space for task performance. In an embodiment of the present disclosure, the server 114 may be any other server based on the requirement for real time advertisement auction on telecommunication notification channels.

FIGS. 2A-2C illustrate a flow chart 200 of the method for performing real time advertisement auction on the one or more telecommunication notification channels, in accordance with various embodiments of the present disclosure. It may be noted that in order to explain the method steps of the flowchart 200, references will be made to the elements explained in FIG. 1. The flow chart 200 starts at step 202. At step 204, the advertisement serving system 112 integrates the plurality of advertisers 110 and one or more telecommunication notification channels with the advertisement serving system 112. At step 206, the advertisement serving system 112 receives the subscriber data from the one or more telecommunication service providers 108. At step 208, the advertisement serving system 112 obtains the subscriber interaction data associated with the plurality of subscribers 102 from the plurality of telecommunication service providers 108. At step 210, the advertisement serving system 112 collect the advertiser data from the plurality of advertisers 110. At step 212, the advertisement serving system 112 analyzes the subscriber data, the subscriber interaction data and the advertiser data. At step 214, the advertisement serving system 112 determines the subscriber context data on the basis of analysis of the subscriber interaction data. At step 216, the advertisement serving system 112 determines the plurality of categories based on the subscriber context data and one or more factors. At step 218, the advertisement serving system 112 sends request to the plurality of advertisers 110 to notify about the space availability for advertisements. At step 220, the advertisement serving system 112 determines the highest bid from the plurality of bids received. At step 222, the advertisement serving system 112 serves the one or more advertisements to the highest bidder based on the plurality of categories.

The flow chart 200 terminates at step 224. It may be noted that the flowchart 200 is explained to have above stated process steps; however, those skilled in the art would appreciate that the flowchart 200 may have more/less number of process steps which may enable all the above stated embodiments of the present disclosure.

FIG. 3 illustrates a block diagram of a computing device 300, in accordance with various embodiments of the present disclosure. The computing device 300 is a non-transitory computer readable storage medium. The computing device 300 includes a bus 302 that directly or indirectly couples the following devices: a memory 304, one or more processors 306, one or more presentation components 308, one or more input/output (I/O) ports 310, one or more input/output components 312, and an illustrative power supply 314. The bus 302 represents what may be one or more busses (such as an address bus, data bus, or combination thereof). Although the various blocks of FIG. 3 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. The inventors recognize that such is the nature of the art, and reiterate that the diagram of FIG. 3 is merely illustrative of an exemplary computing device 300 that can be used in connection with one or more embodiments of the present invention. The distinction is not made between such categories as “workstation,” “server,” “laptop,” “hand-held device,” etc., as all are contemplated within the scope of FIG. 3 and reference to “computing device.”

The computing device 300 typically includes a variety of computer-readable media. The computer-readable media can be any available media that can be accessed by the computing device 300 and includes both volatile and nonvolatile media, removable and non-removable media. By way of example, and not limitation, the computer-readable media may comprise computer storage media and communication media. The computer storage media includes volatile and nonvolatile, removable and non-removable media implemented in any method or technology for storage of information such as computer-readable instructions, data structures, program modules or other data. The computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by the computing device 300. The communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

The memory 304 includes computer-storage media in the form of volatile and/or nonvolatile memory. The memory 304 may be removable, non-removable, or a combination thereof. Exemplary hardware devices include solid-state memory, hard drives, optical-disc drives, etc. The computing device 300 includes the one or more processors that read data from various entities such as the memory 304 or I/O components 312. The one or more presentation components 308 present data indications to a user or other device. Exemplary presentation components include a display device, speaker, printing component, vibrating component, etc. The one or more I/O ports 310 allow the computing device 300 to be logically coupled to other devices including the one or more I/O components 312, some of which may be built in. Illustrative components include a microphone, joystick, game pad, satellite dish, scanner, printer, wireless device, etc.

The foregoing descriptions of specific embodiments of the present technology have been presented for purposes of illustration and description. They are not intended to be exhaustive or to limit the present technology to the precise forms disclosed, and obviously many modifications and variations are possible in light of the above teaching. The embodiments were chosen and described in order to best explain the principles of the present technology and its practical application, to thereby enable others skilled in the art to best utilize the present technology and various embodiments with various modifications as are suited to the particular use contemplated. It is understood that various omissions and substitutions of equivalents are contemplated as circumstance may suggest or render expedient, but such are intended to cover the application or implementation without departing from the spirit or scope of the claims of the present technology.

While several possible embodiments of the invention have been described above and illustrated in some cases, it should be interpreted and understood as to have been presented only by way of illustration and example, but not by limitation. Thus, the breadth and scope of a preferred embodiment should not be limited by any of the above-described exemplary embodiments.

What is claimed is:

1. A computer implemented method for enabling real time advertisement auction on one or more telecommunication notification channels, the computer-implemented method comprising:
enabling integration, at an advertisement serving system with a processor, of a plurality of advertisers and one or more telecommunication notification channels with the advertisement serving system, wherein the plurality of advertisers is integrated through a plurality of advertising tech platforms, wherein the integration is done to serve one or more advertisements to a plurality of subscribers on the one or more telecommunication notification channels in real time, wherein the plurality of subscribers is associated with one or more telecommunication service providers;
receiving, at the advertisement serving system with the processor, a subscriber data, wherein the subscriber data is associated with the plurality of subscribers, wherein the subscriber data is received from the one or more telecommunication service providers, wherein the subscriber data is received in real time;
obtaining, at the advertisement serving system with the processor, a subscriber interaction data associated with interaction of the plurality of subscribers with the one or more telecommunication notification channels, wherein the subscriber interaction data is received from the one or more telecommunication service providers, wherein the subscriber interaction data is received in real time;
collecting, at the advertisement serving system with the processor, an advertiser data from the plurality of advertisers, wherein the advertiser data is associated with the plurality of advertisers, wherein the advertiser data is collected in real time;
analyzing, at the advertisement serving system with the processor, the subscriber data, the subscriber interaction data and the advertiser data, wherein analysis is done using one or more machine learning algorithms, wherein the analysis in done in real time;
determining, at the advertisement serving system with the processors, a subscriber context data, wherein the subscriber context data is based on analysis of the subscriber interaction data, wherein the subscriber interaction data is associated with the plurality of subscribers;
generating, at the advertisement serving system with the processor, a plurality of categories associated with the plurality of subscribers and the plurality of advertisers after analysis of the subscriber data, the subscriber interaction data and the advertiser data, wherein the plurality of categories is generated based on one or more factors and the subscriber context data, wherein the one or more advertisements are provided to the plurality of subscribers based on the plurality of categories, wherein the plurality of categories is generated in real time;
sending request, at the advertisement serving system with the processor, to the plurality of advertisers , wherein request is sent to notify the plurality of advertisers about space availability for advertisement on the one or more telecommunication notification channels; wherein request is sent to the plurality advertisers in real time;
determining, at the advertisement serving system with the processor, the highest bid in a plurality of bids done by the corresponding plurality of advertisers, wherein the bidding is done by the plurality of advertisers to buy space for advertisement on the one or more telecommunication notification channels; wherein the bidding is done in real time; and
serving, at the advertisement serving system with the processor, the one or more advertisements on the one or more telecommunication notification channels through the one or more communication devices, wherein the one or more communication devices are associated with the plurality of subscribers, wherein the one or more advertisements are served in real time.

2. The computer-implemented method as recited in claim 1, wherein the one or more telecommunication notification channels comprise web based communication, text messages, multimedia messages, flash messages, recharge notification and balance notification.

3. The computer implemented method as recited in claim 1, wherein the plurality of advertising tech platforms comprise demand side platforms, mobile advertising exchanges and data management platforms.

4. The computer-implemented method as recited in claim 1, wherein the subscriber data comprises age, location, encrypted MSISDN, address, E-mail address and communication device details.

5. The computer-implemented method as recited in claim 1, wherein the subscriber interaction data comprises calling behaviour, real time call status, balance enquiry request, balance status, call timings, call duration and location of calling.

6. The computer-implemented method as recited in claim 1, wherein the advertiser data comprises name of advertiser, type of advertiser, space required for advertisement, type of advertisement, content of advertisement and duration of advertisement.

7. The computer-implemented method as recited in claim 1, wherein the subscriber context data comprises type of text messages, type of calls, content of multimedia messages, subscriber choices, and subscriber behavior.

8. The computer-implemented method as recited in claim 1, wherein the one or more factors comprises location of subscriber, subscriber calling behaviour, type of advertisement, advertisement relevancy, and content of the advertisement.

9. The computer-implemented method as recited in claim 1, wherein the advertisement serving system sends request to the plurality of advertisers through real time bidding exchange, wherein the request is sent to the plurality of advertisers when the plurality of subscribers interact with the one or more telecommunication notification channels.

10. The computer-implemented method as recited in claim 1, wherein the advertisement serving system receives the plurality of bids from real time bidding exchange, wherein the plurality of bids is done by the plurality of advertisers to buy space for advertisement on the one or more telecommunication notification channels.

11. A computer system comprising:
one or more processors; and
a memory coupled to the one or more processors, the memory for storing instructions which, when executed by the one or more processors, cause the one or more processors to perform a method for real time advertisement auction on one or more telecommunication notification channels, the method comprising:
enabling integration, at an advertisement serving system, of a plurality of advertisers and one or more telecommunication notification channels with the advertisement serving system, wherein the plurality of advertisers is integrated through a plurality of advertising tech platforms, wherein integration is done to serve one or more advertisements to a plurality of subscribers on the one or more telecommunication notification channels in real time, wherein the plurality of subscribers is associated with one or more telecommunication service providers;
receiving, at the advertisement serving system, a subscriber data, wherein the subscriber data is associated with the plurality of subscribers, wherein the subscriber data is received from the one or more telecommunication service providers, wherein the subscriber data is received in real time;
obtaining, at the advertisement serving system, a subscriber interaction data, associated with interaction of the plurality of subscribers with the one or more telecommunication notification channels, wherein the subscriber interaction data is received from the one or more telecommunication service providers, wherein the subscriber interaction data is received in real time;
collecting, at the advertisement serving system, an advertiser data from the plurality of advertisers, wherein the advertiser data is associated with the plurality of advertisers, wherein the advertiser data is collected in real time;
analyzing, at the advertisement serving system, the subscriber data, the subscriber interaction data and the advertiser data, wherein the analysis is done using one or more machine learning algorithms, wherein analysis in done in real time;
determining, at the advertisement serving system, a subscriber context data, wherein the subscriber context data is based on analysis of the subscriber interaction data, wherein the subscriber interaction data is associated with the plurality of subscribers;
generating, at the advertisement serving system, a plurality of categories associated with the plurality of subscribers and the plurality of advertisers after analysis of the subscriber data, the subscriber interaction data and the advertiser data, wherein the plurality of categories is generated based on one or more factors and the subscriber context data, wherein the one or more advertisements are provided to the plurality of subscribers based on the plurality of categories, wherein the plurality of categories is generated in real time;
sending a request, at the advertisement serving system, to the plurality of advertisers , wherein request is sent to notify the plurality of advertisers about space availability for advertisement on the one or more telecommunication notification channels; wherein the request is sent to the plurality advertisers in real time;
determining, at the advertisement serving system, the highest bid in a plurality of bids done by the plurality of advertisers, wherein the plurality of bids is done by the plurality of advertisers to buy space for advertisement on the one or more telecommunication notification channels; wherein the plurality of bidding is done in real time; and
serving, at the advertisement serving system, the one or more advertisements on the one or more telecommunication notification channels through the one or more communication devices, wherein the one or more communication devices are associated with the plurality of subscribers, wherein the one or more advertisements are served in real time.

12. The computer system as recited in claim 11, wherein the one or more telecommunication notification channels comprises web based communication, text messages, multimedia messages, flash messages, recharge notification and balance notification.

13. The computer system as recited in claim 11, wherein the plurality of advertising tech platforms comprises demand side platforms, mobile advertising exchanges and data management platforms.

14. The computer system as recited in claim 11, wherein the subscriber data comprises age, location, encrypted MSISDN, address, E-mail address and communication device details.

15. The computer system as recited in claim 11, wherein the subscriber interaction data comprises calling behaviour, real time call status, balance enquiry request, balance status, call timings, call duration and location of calling.

16. The computer system as recited in claim 11, wherein the advertiser data comprises name of advertiser, type of advertiser, space required for advertisement, type of advertisement, content of advertisement and duration of advertisement.

17. The computer system as recited in claim 11, wherein the one or more factors comprises location of subscriber, subscriber calling behaviour, type of advertisement, advertisement relevancy, subscriber choices and content of the advertisement.

18. The computer system as recited in claim 11, wherein the subscriber context data comprises type of text messages, type of calls, content of multimedia messages, subscriber choices and subscriber behavior.

19. The computer system as recited in claim 11, wherein the advertisement serving system sends request to the plurality of advertisers through real time bidding exchange, wherein request is sent to the plurality of advertisers when the plurality of subscribers interact with the one or more telecommunication notification channels.

20. The computer system as recited in claim 11, wherein the advertisement serving system receives the plurality of bids from real time bidding exchange, wherein the plurality of bids is done by the plurality of advertisers to buy space for advertisement on the one or more telecommunication notification channels.

21. A non-transitory computer-readable storage medium encoding computer executable instructions that, when executed by at least one processor, performs a method for real time advertisement auction on one or more telecommunication notification channels, the method comprising:
enabling integration, at a computing device, of a plurality of advertisers and one or more telecommunication notification channels with an advertisement serving system, wherein the plurality of advertisers is integrated through a plurality of advertising tech platforms, wherein integration is done to serve one or more advertisements to a plurality of subscribers on the one or more telecommunication notification channels in real time, wherein the plurality of subscribers is associated with one or more telecommunication service providers;
receiving, at the computing device, a subscriber data, wherein the subscriber data is associated with the plurality of subscribers, wherein the subscriber data is received from the one or more telecommunication service providers, wherein the subscriber data is received in real time;
obtaining, at the computing device, a subscriber interaction data, associated with interaction of the plurality of subscribers with the one or more telecommunication notification channels, wherein the subscriber interaction data is received from the one or more telecommunication service providers, wherein the subscriber interaction data is received in real time;
collecting, at the computing device, an advertiser data from the plurality of advertisers, wherein the advertiser data is associated with the plurality of advertisers, wherein the advertiser data is collected in real time;
analyzing, at the computing device, the subscriber data, the subscriber interaction data and the advertiser data, wherein analysis is done using one or more machine learning algorithms, wherein analysis in done in real time;
determining, at the computing device, a subscriber context data, wherein the subscriber context data is based on analysis of the subscriber interaction data, wherein the subscriber interaction data is associated with the plurality of subscribers;
generating, at the computing device, a plurality of categories associated with the plurality of subscribers and the plurality of advertisers after analysis of the subscriber data, the subscriber interaction data and the advertiser data, wherein the plurality of categories is generated based on one or more factors and the subscriber context data, wherein the one or more advertisements are provided to the plurality of subscribers based on the plurality of categories, wherein the plurality of categories is generated in real time;
sending request, at the computing device, to the plurality of advertisers, wherein request is sent to notify the plurality of advertisers about space availability for advertisement on the one or more telecommunication notification channels, wherein request is sent to the plurality advertisers in real time;
determining, at the computing device, the highest bid in a plurality of bids done by the plurality of advertisers, wherein the plurality of bids is done by the plurality of advertisers to buy space for advertisement on the one or more telecommunication notification channels, wherein the plurality of bidding is done in real time; and
serving, at the computing device, the one or more advertisements on the one or more telecommunication notification channels through the one or more communication devices, wherein the one or more communication devices are associated with the plurality of subscribers, wherein the sus are served in real time.

22. The non-transitory computer-readable storage medium as recited in claim 19, wherein the subscriber interaction data comprises calling behaviour, real time call status, balance enquiry request, balance status, call timings, call duration and location of calling.
